(19) United States
(12) Patent Application Publication
(10) Pub. No.: US 2009/0031216 A1
(43) Pub. Date: Jan. 29, 2009

(54) PREFLIGHTING FOR WEB PUBLISHING

(75) Inventors: Kurt William DRESSEL, Epsom (GB); Robert John COOP, Stansted Mountfitchet (GB)

Correspondence Address: Workman Nydegger;1000 Eagle Gate Tower, 60 East South Temple, Salt Lake City, UT, 84111, US

(73) Assignee: VIO WORLDWIDE LIMITED, London (GB)

(21) Appl. No.: 12/180,415

(22) Filed: Jul. 25, 2008

Related U.S. Application Data
(60) Provisional application No. 60/952,130, filed on Jul. 26, 2007.

(51) Int. Cl. G06F 17/00; G06F 3/048

(52) U.S. Cl. 715/255; 715/751

(57) ABSTRACT

A computer-implemented method for preflighting of electronic documents containing content intended for web publication is described together with an integrated system for performing the preflighting checks and managing the workflows associated with web publication of content. The method allows the web publisher to predefine rules for the preflighting checks in accordance with its technical specifications for web publication and also personalize the rules according to the sender of the document. Rules may be defined and applied to content indirectly incorporated by embedded links to third party hosted web sites. The system provides for a high degree of flexibility in the way the rules may be specified and implemented and also allows for the use of other reference identifiers, which provide a separate channel by which booking and reconciliation functionality may be achieved associated for any given publication of content.

### CROSS-REFERENCE TO RELATED APPLICATIONS

This application claims the benefit of U.S. Provisional Application Ser. No. 60/952,130, filed Jul. 26, 2007, which is incorporated herein by reference.

### FIELD OF THE INVENTION

The present invention relates to preflighting of electronic documents containing content intended for web-based publication and to a system for managing the associated work flow.

### BACKGROUND TO THE INVENTION

In the context of publishing, preflighting of a document intended for publication generally refers to the pre-checking of the document for errors and for compatibility with accepted standards for the publishing of such documents. For a long time, the checking of documents intended for paper publication by printing was performed manually. The document could be checked by the author after its creation, by the publisher before further processing and publication, or else by some intermediate third party specializing in such testing before forwarding the preflighted document to the publisher.

With the advent of computers and desktop publishing software, more automated techniques have been developed to perform the desired checks prior to the final printing of a document. U.S. Pat. No. 5,963,641 describes a software implemented device for preflighting electronically-recorded documents prior to their final output, whether by printing, transmission or recording. US2004/003483 describes a preflight system for analyzing an electronic document created by a particular software application, and which comprises a preflight engine and a preflight client for each output component of the application. The system provides for constant preflighting of the output from the creative application during the creative process, and can handle file formats intended for either conventional print or on-line publication.

However, despite these developments, no system has yet been proposed that is suitable for preflighting documents containing content specifically intended for web publication against required specifications. Nevertheless, the need for checking the suitability of externally supplied artwork for use on websites has been identified as a serious problem by leading web publishers, their advertisers and editorial contributors. This is particularly true in the context of web advertising, where the content is destined for an advertisement on a website.

Nevertheless, similar problems to those experienced in print publishing are, in fact, experienced in the web publishing world, albeit with different technical manifestations. Many of the reasons why web publishers have not hitherto acknowledged the problems of receiving incorrectly built artwork stem from the relative immaturity of web publishing processes and the willingness to date of web publishers to accept operational inefficiencies to deal with problems post receipt of the artwork, as web revenues are fast growing.

In the case of artwork destined for the internet, there are software applications that assist web artwork creators to build it correctly in general terms, but there is nothing to enable the intended web publishers or other intended recipient to specify and vary their own criteria just as print publishers can today.

With the proliferation of web-based advertising and other externally contributed web artwork, the number of web-based artwork materials, their formats and their sources have increased to the point where it is increasingly difficult and time-consuming for the recipients of the material to confirm that the received material is fit for use on the publishers website, and in the case of advertising conforms to the particular advertising specifications sold. This may, for example, be manifested in the guise of artwork that is not in a file format that is supported on the publisher's website; the length of an animated clip is longer than permitted or purchased; or the mechanical size of the delivered material is not the correct size to fit the space sold to the buyer.

Furthermore, the problem of checking the validity of content is made more difficult by the fact that over 80% of content is stored and served to consumers by third party servers. In this instance, the content is never physically sent to the publisher, but rather the sender submits links to be inserted in the ad call by the publisher or their agent or representative. As the web continues to mature, it is expected that the there will be a large variance in the acceptance specifications and in the ability of various publishers to handle materials intended for web publication. Thus, not only will the content become more diverse, thereby requiring more rigid checking, but the specifications accepted by various publishers will also become more diverse.

There is therefore a clear need for a system that can provide the desired preflighting checks on content intended for web publication, and in particular a system that can handle the unique technical problems associated with content produced in the wide range of formats that can be published on-line. Moreover, there is a need for an integrated system that can handle the workflows associated with a third party web publication processes, including not only the preflighting functionality but also functions such as tracking, auditing and reconciliation.

### SUMMARY OF THE INVENTION

According to a first aspect of the present invention, there is provided a computer-implemented method of preflighting an electronic document containing content provided by a first party and intended for web-based publication by a second party, the method comprising the steps of:
accessing the electronic document from the first party;
checking characteristics of the document for compliance with a set of rules, the rules being predefined by the second party and corresponding to specifications for web publication of content by the second party;
providing to the first party an indication of the level of compliance of the document characteristics with the predefined rules; and,
submitting the preflighted document for web publication of the content by the second party subject to the level of compliance.

In this manner the invention provides for the preflighting of a large range of content in electronic format that is intended for web publication and whereby the testing is performed against specifications defined by the publisher of the content. The first party providing the document might be the party that actually created the document or else another party providing access to the document for preflighting on behalf of the document creator. The document may actually be accessed from the first party in a number of ways, including receiving the document directly from the first party or else retrieving it from some specified location. Similarly, the party actually publishing the content may be the second party or it may be a third party publisher acting on behalf of the second party. Nevertheless, it will be the second party that ultimately specifies the set of rules for the preflighting checks. As with existing preflighting systems, the method steps of the present invention may be executed locally on a sender's workstation, on a remote third party server providing a dedicated preflighting service, or else on a server associated with the publisher.

It is desirable that several different levels of compliance may be allowed for and indicated. It is further possible that each may result in a different action in relation to whether the document is submitted for web publication of the content.

Preferably, when the indication comprises a failed level of compliance, the method further comprises the step of indicating to the first party how to correct errors in the document for compliance. This would be the case where errors in the document are too severe to permit the content to be submitted for web publication, but an indication is given as to how some or all of the errors may be corrected. Once corrected, the first party would resubmit the corrected document for further preflighting checks.

When the indication comprises an adequate level of compliance, it is preferred that the method further comprises the step of sending to the first party an invitation to either correct errors in the document and resubmit it for further preflighting or to authorise submission of the preflighted document including the errors for web publication of the content by the second party subject to acceptance of conditions specified by the second party. This would be the situation where the errors are not considered severe enough for a failure warning, and the document could be submitted for publication of the content, subject to conditions specified by the publisher and accepted by the sender. In this case the sender is provided with a cautionary warning and can either agree to the conditions for publication or else correct the errors and then resubmit the corrected document for further preflighting checks.

In the event that the first party is prepared to proceed without correcting the errors, the method further comprises the steps of receiving authorisation from the first party in response to the invitation, submitting the preflighted document including the errors for web publication of the content by the second party together with the indication of the level of compliance, and sending a confirmation to the first party that the document has been submitted.

If sufficient information is available to correct minor errors, an alternative approach to handling documents with an adequate level of compliance is to automatically correct the errors. In this case the method may further comprise the steps of automatically correcting errors in the document, submitting the corrected preflighted document for web publication of the content by the second party together with the indication of the level of compliance, and sending a confirmation to the first party that the document has been submitted.

Finally, there is the situation where a good level of compliance is achieved, which is sufficient to allow submission of the document for publication of the content without further action. In this case it is preferred that the method further comprises the steps of submitting the preflighted document for web publication of the content by the second party together with the indication of the level of compliance, and sending a confirmation to the first party that the document has been submitted.

The predefined set of rules used to preflight a document may be stored locally, but typically the rules will be accessed from a remote server, as and when required. The rules data may be stored in a database associated with the publisher's server or else a hosted third party server.

It is preferred that the rules correspond to a hierarchical specification structure, with general rules relating to high-level structure of a website towards the top of the specification and a more detailed set of rules governing the low-level format of specific elements at the bottom of the specification. The rules may have default settings, which correspond to an industry standard or else to a publisher specific minimum. Preferably, a complete publisher specification also comprises three different types of specification, namely: a technical specification, for parameters such as ad unit, permissible file size, alternative text requirements, and the like; a management specification, for creative deadlines and submission deadlines which can vary from one type of inventory or media type to another, for example; and an editorial specification, which include definitions of acceptable content.

The rules are predefined by the second party and may be modified by the second party, as and when required, to reflect changes in publishing specifications or else changes associated with the first party sender. This can readily be achieved by updating the appropriate rules data stored in the secure database. The updates may be performed automatically or manually depending on the publisher's requirements. Automatic updates maybe more appropriate where the changes relate to global changes in publishing specifications.

In a further element of flexibility provided by the present invention, the set of predefined rules used to check a document may be dependent on the identity of the first party. In this way, the publisher may not only define rules governing general specifications for web publishing, but may also make the particular rule set applied specific to the first party providing the content. This may be for reasons of type of content supplied by that party, which is of particular relevance to content for web advertisements. In a further variation on this concept, the level of compliance required for submission of the document may also be specified by the second party, and may be made dependent on the identity of the first party. Thus, the web publisher may, for example, allow a greater acceptable margin of error for an established or valued customer, and at the same time impose a stricter degree of compliance for newer, untried customers. This facility can be implemented on a scheduled or ad hoc basis. The ability to implement sender specific rules and levels of compliance allows for a “grading” of the preflighting. Although grading will typically be applied between different users (senders), it may also be applied between different submissions from the same user.

The present invention also allows for several other monitoring facilities, which may be used for tracking or reconciliation purposes. For example, the method preferably further comprises the step of receiving or assigning a unique identification (ID) reference associated with the electronic document, which may include many elements of digital artwork. This unique ID reference can act as a tracking number, which can be used by all parties to track the progress of an item in the system from submission and testing through to the final web publication. The ID reference will typically be assigned by the second party prior to the creation and testing of any content. Thereafter, the ID reference will be associated with the electronic document and the second party, and can be checked against data supplied by the second party.

This ID reference provides a separate mechanism, or data stream, for data associated with the document to be exchanged. Submission of the document for web publication of the content by the second party may even be made subject to validation of some aspect of the ID reference against data received from the second party. This feature is particularly useful where publication of particular content is associated with the ID reference, which both the sender and publisher have knowledge of. Such a feature provides a degree of authentication for security purposes. Moreover, the set of predefined rules applied to a particular document may be made dependent on the ID reference. In this way, particular content may be reconciled with a particular job and a particular set of rules for preflighting. This feature allows the web publisher to define specific rules for a particular job. For example, a given job may be associated with a certain advertising space and the particular size and format of the advert can be enforced by the application of publisher specified rules associated with the ID reference.

The method may further comprise the step of associating a unique certification code with the content in the preflighted electronic document intended for web publication. The certification code would be created during testing of the electronic document. The code could take several aspects of the content and use an algorithm to convert these into a number that could be verified and would be very difficult to fake, for example using the file weight, the number of code lines and the number of code characters. Any changes to the content intended for publication will impact one or all of these elements and make the code invalid. The inclusion of the successful test date in the code would provide a further useful audit function. The certification code provides another level of security as the system could flag any mismatches, if the content has been tampered with in any way. Indeed, the system could prevent such content from serving, and so changing the content on a third party server would become impossible without running and passing a test first.

When a particular publishers page containing advertising is served, it includes a so-called “Ad Call” (sometimes called an Ad Tag), which is a relatively complex piece of code included by the publisher which has a number of purposes. These include acting as a placeholder for the advert, ensuring the ad is served after the page content and containing targeting information to determine which ads are served. Advantageously, the present invention can exploit the presence of this Ad Call code by including a certification code as part of the Ad Call.

Typically, an electronic document containing content intended for web publication will also contain metadata associated with the content. It is therefore preferred that the set of predefined rules includes rules corresponding to specifications for the type and form of the metadata. Metadata may also be sent and received with the identification reference, if one is supplied. In this case, it is preferred that the method further comprises the steps of accessing metadata associated with the ID reference, and preflighting the metadata by checking characteristics of the metadata for compliance with a set of rules, the set of rules being predefined by the second party and corresponding to specifications for the type and form of metadata.

The presence of metadata in a separate data stream associated with the ID reference allows for booking and payment reconciliation functionality. Indeed, the actual publication and reconciliation steps need not be performed by the same party, for example where the publisher actually subcontracts the web publishing to a third party. In this case it is preferred that the step of submitting the preflighted document for publication of the content by the second party comprises the steps of forwarding the preflighted document to a third party for web publication of the content on behalf of the second party, and forwarding the preflighted metadata associated with the ID reference to the second party for reconciliation purposes. The third party may be specified either by the first party or by the second party.

The set of rules predefined by the second party for preflighting an electronic document may be extensive and cover a range of parameters. Some parameters, particularly for static media formats, may be similar to those employed in preflighting for print documents, although aspects of these will be web specific. For example, the set of rules may include rules corresponding to specifications for file format, file weight, border requirements, font, physical dimensions of formatted content, and the like.

However, the web allows for publication using rich media formats, which may comprise audio and/or animated visual content. It is therefore preferred that the set of rules include rules governing the specifications for this type of media format. For example, audio and/or animated visual content may be governed by parameters such as file type, file weight, file size, the existence of user controls, the number of animation loops, physical expansion limits, duration of display, and the like. Furthermore, the very nature of web publishing means that much of the actual content to be published is hosted and served remotely from other third party web sources and is referenced and incorporated in the electronic document by way of a link to the actual content source. Therefore, it is preferred that the set of rules include rules corresponding to specifications for links of this type, including website links, tags for searching, tags for tracking, and the like. Other types of media format may be supported, such as streaming media, and rules associated with the specification for these formats may also be included.

Moreover, as it is desirable that the remotely hosted content is also preflighted for compliance, it is preferred that the method further comprises the steps of identifying in the document embedded links to external sources of content, accessing the content from the external sources via the embedded links, and checking characteristics of the external content for compliance with the set of rules predefined by the second party. For this type of content, the predefined rules may also include rules corresponding to specifications governing the acceptable security protocols used by links to external sources of content.

According to a second aspect of the present invention there is provided a computer program product comprising computer executable code for implementing the method of the first aspect. The code may be run on a local or a remote machine to perform the preflighting checks.

According to a third aspect of the present invention there is provided a networked computer system for preflighting an electronic document containing content provided by a first party and intended for web-based publication by a second party and for managing the workflow between the first party and the second party, the system comprising:
a first database comprising data relating to particular web publication jobs;
a second database comprising data relating to second party publishers of web content;
a third database comprising data relating to specifications for web published content;
a fourth database comprising data relating to first party providers of content intended or web publication; and,
a processor adapted to execute computer code for performing the method of the first aspect, the processor being in communication with each of the first, second, third and fourth databases.

In this way, a complete integrated system is provided for managing an on-line interaction between the various parties involved with the generation, preflighting and serving of web published content. Access to the centrally-maintained databases will typically be via the internet. The first and second parties will also typically interact with the on-line system over the internet by means of one or more computer terminals, which display a proprietary graphical user interface. The interface allows the parties to monitor the progress of particular jobs in the system by means of displayed status flags.

Using the system, a second party web publisher can initiate a publication process by submitting a job ticket containing relevant data to the system, which in turn allocates a job ticket number to the job and stores the relevant data in the first (job) database, from where it can be accessed by the first party seeking to publish content on the web. Data on the relevant first party (for example an agency) is obtainable from the fourth database. The second party can also submit and modify specifications determining the preflighting rules to be used, and these are stored in the third (specification) database, with data on the second party defining the specification is obtainable from the second database. Equally, the system enables the first party to access and query data stored in the databases, for example to determine the identity of one or more publishers who have defined specifications for web publication that closely match those sought by the first party.

Other functionality of the system stems from the features described above in relation to the method which is implemented within the system. The provision of additional unique identifiers allows both parties to reconcile particular content intended for publication with a particular job, and also facilitates a booking system. Both parties are able to perform automated tests on documents containing content and metadata and track the status of the testing. The system does not replace management procedures internal to either party, but does manage those parts of the process where interaction is required.

As will be appreciated by those skilled in the art, the present invention provides a very powerful tool for the computerised preflighting of electronic documents containing content intended for web publication and for managing the progress of the document. An important feature of the invention is the ability for the web publisher to specify rules for the preflighting checks and the degree of flexibility associated with the way these rules may be specified and implemented. The provision of other reference identifiers allows a separate channel for booking and reconciliation purposes, and certification code for validation and auditing purposes, thereby further enhancing the commercial applicability of the invention.

### BRIEF DESCRIPTION OF THE DRAWINGS

Examples of the present invention will now be described in detail with reference to the accompanying drawings, in which:

FIG. 1 illustrates the submission of a “creative” for automated preflighting and subsequent web publication according to the present invention;

FIG. 2 shows the workflow for web publication when initiated by the planner;

FIG. 3 shows the workflow for web publication when initiated by the agency; and,

FIGS. 4 to 21 illustrate the interactions between the various parties involved in a web publication work flow initiated by the publisher.

### DETAILED DESCRIPTION

The present invention provides the capability to check remotely web artwork against a web publishers specifications before the artwork is submitted to the publisher, and as part of an application that not only facilitates this but also captures the results, and then makes both the artwork and the metadata available to the relevant parties according to pre-defined rules. While there are solutions on the market that assist web art workers in building material in a workmanlike and sound way, there are no solutions for enabling web publishers to export and enforce their specifications upstream to ensure that incoming web materials are not only well-built, but also built to their specifications before they are received.

The invention also allows the publisher to identify the sender of the content by its logon details, and change the criteria for acceptance not only by reference to the content and the specifications of the intended website pages for which it is destined, but also by reference to the identity and/or characteristics of the sender. For example, a regular and experienced sender may be allowed a larger tolerance against the standard rules as the receiver expects material form that source still to be acceptable, whereas a new and unproven sender might be expected to adhere 100% to the standard acceptance criteria. Or a particularly desirable and high-spending customer (e.g. a major brand advertiser) may be allowed to send files with errors, on the basis that the receiver (e.g. a publisher) prefers to absorb the cost of fixing such errors from such a customer rather than rejecting the material for failing to comply fully with the receiver's rules and specifications.

The present invention provides a preflighting tool or engine which ensures that web artwork is not released to the publisher from the senders desktop (or alternatively, from a third party server sitting between the sender and the publisher) unless it has been validated according to the publishers rules, which may be qualified for certain senders. Only then will the artwork automatically become available to the publisher or its contractor, together with associated metadata, with confirmation to the sender. As a result, the publisher can save costs and time that would otherwise be required for checking and perfecting materials that have been sent in that do not conform to specification. In addition, by being confident that incoming artwork will comply with its specifications, publishers can have later copy deadlines, allowing more time for advertising sales and creative changes.

The computer-implemented preflighting tool will refer to a specifications database, which may be created by a remote third party and which will allow each publisher to set their own acceptance criteria for delivery of content, including web advertisements. In order to be fully effective, the tool must therefore check the validity of physical content sent to publishers, and also follow the path of any links, such as tags to third party servers, and check the suitability of the content therein stored before reporting a ‘pass’, ‘caution’ or ‘fail’ back to the user.

A particular application of the invention is in web advertising, as this typically involves artwork created and supplied by parties over whom the publisher has no control, and also where the good presentation of the artwork on the publishers website is fundamental to the business relationship between the parties. It also reflects the fact that the artwork supplier, the advertiser (or at least its agent), is the publisher's customer, and yet it is the publisher's specifications that need to be complied with. Publishers are naturally reluctant to reject advertising and the associated revenues, and yet accepting advertising materials that do not present properly on the publishers website is also not acceptable because it results in increased labour costs and time delays for the publisher. Additionally, non-compliant and/or late artwork is often at the core of billing disputes. Therefore, in the following description, examples are directed to the application of the present invention in web advertising. However, as will be appreciated by the skilled person, the applicability of the invention is much wider.

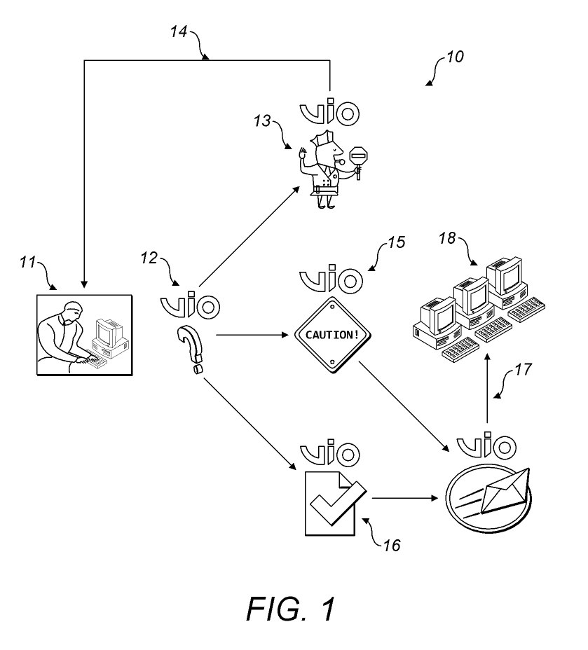

As shown in FIG. 1, with the present invention, a simple workflow 10 would involve the sender 11 selecting the artwork (such as an advertisement) and presenting this online to the preflighting system 12, which is referred to under the name ‘Vio’. The sender would then select the intended recipient website and, optionally and if known, a booking to which the advertising material relates or other relevant reference for tracking and reconciliation purposes. The preflighting system 12 would then automatically check the artwork against the specifications attributable to that website and, optionally and if known, the booking or other reference, and possibly also the identity of the sender to assess whether derogations from generally applicable rules are to be applied.

Several particular situations can be identified, as regards the level of compliance of the artwork with the publisher's rules, and these will result in different actions. Three particular cases are as follows:

(i) If the artwork fails the check 13, the sender would immediately be automatically notified 14 and invited to make the necessary corrections.

(ii) If the artwork fails the check 15 but in a way in which the publisher has determined is acceptable subject to conditions, then the sender is warned of this status and the implications before being invited either to correct the artwork or to submit it subject to the publisher's conditions. Both the sender and the publisher are advised of the sender's acceptance of the publisher's conditions, and the artwork, together with the associated metadata, is automatically submitted 17 to the publisher 18 or its contractor according to the publisher's rules and requirements. Submission of the artwork is confirmed to the sender, and a unique tracking number ascribed to it.

(iii) If the artwork passes through the checks 16 without error, then the sender and publisher are automatically advised of this and the artwork, together with the associated metadata, is automatically submitted 17 to the publisher 18 or its contractor according to the publisher's rules and requirements. Submission of the artwork is confirmed to the sender, and a unique tracking number ascribed to it.

Although a preferred application relates to web advertising material being supplied to a web publisher, similar issues arise for any externally contributed web materials where the publisher cannot ensure the artwork is created in the first place according to its specifications. Unlike in print publications, the nature of submitted artwork is highly variable, as it may involve, for example, flat art in various different formats, animation, video, combinations of audio and visual materials, links to other websites, tags for searching and other embedded information for tracking and other purposes. Some, or all of these, need to be checked for compliance.

As web media evolve, especially with the increasing use of user-supplied material in publishers' websites, the variety and complexity of the issues that need to be checked and validated will grow. For example, in the print world, the publisher can verify rights attaching to incoming materials using a range of existing mechanisms, whereas the nature of the web and the dynamic relationship of different sites and sources feeding sites, makes digital rights management far more complex. The ability to rights-check and validate incoming material, by checking against publisher-specified databases before it is received, is a clear further application of this invention. A further application of the invention would be in the implementation and enforcement of policy checks. For example, a publisher targeting children needs to check for adult content, and being able to do this remotely according to publisher-specified criteria before the material is submitted would be valuable.

With regards to advertising, as the preflighting tool may be developed to integrate the checking of the advertisement content with the purchase information associated with the advertisement. This will be done by tracking the progress of the advertisement from the point of media sale, through the creative cycle, and finally reconciling the finished and delivered advertisement right the way back to the original sales booking. The system may be expanded to allow web adverts to not only be checked against publishers' specifications, but also to be checked for compatibility across multiple computer platforms and operating systems. This feature is particularly useful where an advert or piece of artwork will be served by one or more third party servers, which may employ different platforms and systems too each other and to any staging server on which the artwork has been trialed.

The system may be further adapted so as to be capable of ‘scanning’ the contents of web materials, and taking appropriate action accordingly. Examples such as inappropriate language, direction to non-secure websites for financial transactions and the like could lead to the content being rejected by the publisher. In this case the system will perform a type of ‘optical character recognition’ in order to recognize words made from pixels rather than characters, and thereby enable this function to work effectively.

We now consider some aspects of the system in more detail and particularly the workflows associated with the whole publication process, whether initiated by the publisher or by an agency which provides the creative artwork for publication. Generally before any particular work flow commences, an insertion order (IO) is generated, which forms the contract between a publisher and an advertiser (or agency working on behalf of the advertiser). In the case of an advertisement, the will generally contain all of the information necessary to define and manage a particular advertising campaign.

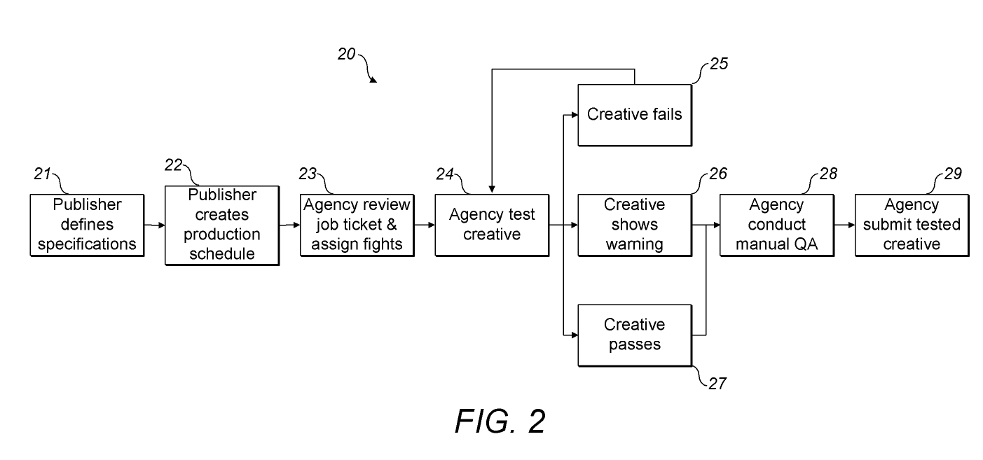

FIG. 2 shows the workflow 20 associated with submission of creative artwork when the process is initiated by a planner. In the first step, the publisher uses the system to create their particular publisher specifications 21. The planner can then create a “Production Schedule” 22, which is essentially a subset of the IO, identifying a particular campaign and allowing particular requirements to be specified. Each Production Schedule 22 includes detailed information regarding the campaign and work assignment and is automatically allocated a unique identifying number by the system and has an associated “job bag” for storing the related documents and test results. Each Production Schedule will usually have a number of “Line Items”, each of which will typically comprise several “Flights”. The Flight constitutes the lowest level or smallest unit within a given Production Schedule. In this way, each job may contain a number of different pieces of creative artwork, each associated with particular Flights, which may be grouped into Line Items. Each Line Item and Flight will have a unique identifier and each Flight will contain a link to a relevant “atom specification” required for testing.

The atom specification is the specification for a particular type of publisher inventory taking into account factors such as slots for advertising on the website owned by the publisher, the channel structure of the website (whether horizontal or vertical) and the format of media to be used. Atom specifications build up into channel specifications, which in turn build up into higher level property specifications associated with particular websites. Finally, where appropriate, a number of property specifications constitute a publisher specification. This tree-like specification structure provides a convenient and powerful way to build up a publisher specification.

To ensure maximum flexibility in defining, assigning and using publisher specifications, the following approach is adopted:

1. There are three specifications which collectively make up the publisher specification:
(a) Technical specifications—such as inventory dimensions, permissible file size, alternative text requirements, and the like;
(b) Management specifications—for creative deadlines which can vary from one type of inventory type, media type, or channel, to another; and,
(c) Editorial specifications which include definitions of acceptable content.

2. Technical specifications will use Universal Advertising Package standards defined by the relevant IAB as the default settings. In the UK and Europe this will be the Internet Advertising Bureau and in the USA it will be the Interactive Advertising Bureau. These default settings can be overwritten and augmented by the publisher as required.

3. Specifications are defined by channel. A channel is an area of the publisher website which requires a separate specification for whatever reason. It may be advisable for publishers to define channels along organizational or hierarchical grounds even if no differences in specification currently exist as a form of future proofing.

4. Defining different channels is supported through the use of parent/child relationships from the homepage down through a website. For example, if a publisher defines a particular specification for the homepage (assumed to be the highest-level channel), they can chose to adopt these settings for subsequent channels.

5. If channels have been defined, the individual specifications applicable to each type of inventory are stored separately. This provides an ability to set different specifications for similar inventory throughout a website. For example, the “Leaderboard” on the homepage may have a more stringent specification than a Leaderboard on a lower-level page.

6. A publisher can set ‘tolerances’ within their specification, which would normally apply to the technical specification only. The tolerances will provide flexibility allowing a ‘pass’, ‘warning’ or ‘fail’ instead of a simple ‘pass’ or ‘fail’.

7. Used in conjunction with tolerances, will be the ability to set ‘grades’ against agencies. Grading information will be held in a publisher database separate from an agency database that is also maintained. This will enable each publisher to assign their own grades to agencies instead of each agency having a universal grade. Publishers can assign a particular terminology to an agency, such as ‘trusted’, ‘standard’ or ‘not trusted’. ‘Trusted’ Agencies will have higher tolerances assigned than ‘standard’ agencies, with ‘not trusted’ having lower tolerances still. Grading enables a publisher to configure any on-line exchange system to manage problematic agencies more closely than those who perform consistently well.

8. Not all elements of the specification can be tested automatically. To help agencies comply with these elements, the system will provide an on-screen checklist for manual quality assurance.

Referring again to FIG. 2, once a Production Schedule has been created 22, the advertiser or agency can review 23 the Production Schedule and then assign 23 different parts of the associated job ticket, for example particular flights, to different creative teams, for the production of the creative artwork (“creative”). Once the creative elements have been completed, the relevant agency user presents the completed creative for preflight testing 24 against the relevant atom specification. The user selects the creative to be tested by defining a tag or by placing the actual creative in the Job Bag folder concerned. The screen refreshes to display the filename, dimensions (in pixels), file weight (in kilobytes) and file format. The system also displays the creative to provide a visual verification. If a tag is defined but no creative exists at that location, a plain English error message is displayed. The testing process commences once the user selects the creative or tag and selects ‘Test’. The testing system functionality of the system is characterized by the following features:

1. The screen displays the test results. Test results are listed with corresponding red 25, amber 26, and green 27 findings. Amber 26 and red 25 findings allow the user to link to an explanation of why the creative has not passed, or has passed with qualification.

2. Tests can be saved as part completed to be continued later.

3. As well as the automated test results, a checklist is presented for manual checks. These are stated as questions requiring a positive answer such as ‘Animation does not loop more than three times?’. Again a link to a full explanation is offered.

4. If an automated test could not run for whatever reason or failed to verify a result one way or the other, this item is added to the checklist for manual checking.

5. The user can retest the creative as many times as possible and a complete retest is conducted—in the course of addressing one issue, another may arise. This includes a refresh of the checklist of manual checks, so users are advised to satisfactorily complete automated tests first.

6. On verifying that the manual criteria are met and checking each item off, the user selects ‘Submit as Complete’ (this button is only visible once all automated tests are green or amber and all manual checks have been verified).

7. The system displays the Job Ticket with the relevant Flight displayed as tested (this is denoted by a green or amber background to the Flight's reference number box (any amber finding will trigger an amber status flag for the entire Flight).

8. At the end of the Flight entry on the Job Ticket, the ‘Test’ link at the end of the Flight entry is replaced by a ‘Retest’ link.

9. Selecting the green or amber reference number box will display the full test results. Selecting the ‘Retest’ link will carry out a complete test cycle. Where retesting has taken place, the user can select previous results from the results page.

10. Where a part completed test has been saved, it will display on the Job Ticket as a red 25 result. Only once all results are green 27 or amber 26, can the user submit the entire Job Ticket as complete.

The publisher specification, and particularly the detailed atom specification, may comprise an extensive range of tests to be performed and thresholds to be met. Table 1 details a range of standard tests that may be performed. Also indicated is whether an IAB standard exists for the particular parameter and also whether an automatic test may be performed or whether a manual check may be more appropriate. Table 2 details an extensive list of tests that may be performed in respect of rich media formats. Further tests will be required for other types of media format, such as streaming media.

Once testing, or re-testing, has been completed the tested creative may be in an acceptable form for submitting to the publisher. Indeed, this may happen automatically, if a sufficient degree of compliance has been found during the automated preflighting. However, it is preferable for the sender (advertiser or agency) to be able to perform final manual quality assurance checks 28 at this stage. Manual testing 28 can be used for a final check and may include those tests which the automated preflighting could not perform for some reason and also those tests which the automated preflighting is not programmed to perform. Testing of the particular piece of creative, for example a flight, is now complete and can be submitted or forwarded for submitting to the publisher.

At this point the system assigns a unique certification code to the piece of creative, which calculates a unique identifier associated with the creative. This may be a type of checksum performed using particular file characteristics and may also have an associated timestamp. This unique piece of code accompanies the creative to publication server, where it ensures that the creative can not be tampered with or replaced by other creative in its particular publication slot on the end web page. This feature is particularly valuable where the creative is being served by a third party over which the publisher (and agency) has no control.

Finally, the automatically and manually-tested creative is ready for submission 29 to the publisher. At this point, if a particular job includes several Line Items or Flights, for which the actual creative may have been generated by different parties or individuals, then all of the tested components are collected to form the job, which is verified as complete and to specification, and then forwarded to the publisher. The collation of the various components of a given job may be performed by an agency account manager, who allocated the creative tasks to the different parties or individuals in the first place. The publisher will typically review the creative and test results and verify the certification code prior to approving the creative for web publication. The creative is then allocated to the allotted slot on an end web page, which may be served by the publisher's own server or else by one or more third party servers.

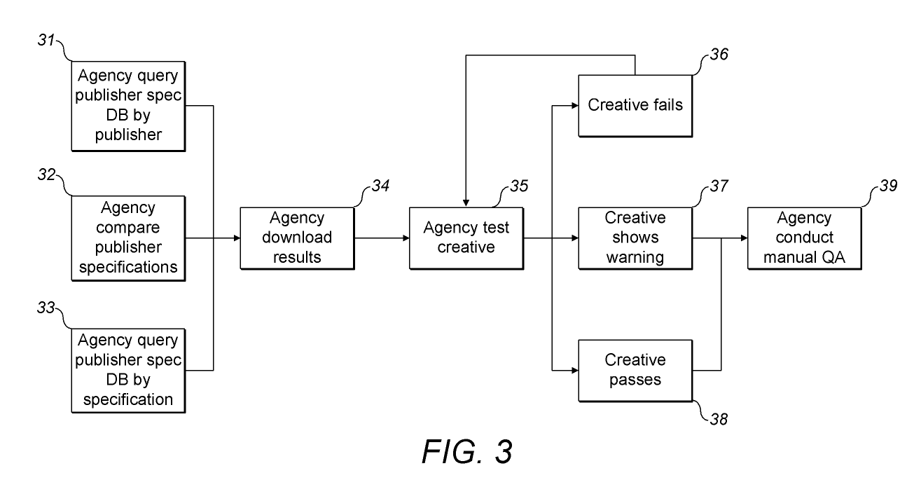

As shown in FIG. 3, although the core preflighting checks remain the same, the overall workflow 30 associated with submission of creative artwork is a little different when the process is initiated by the agency submitting the creative. In this case the agency may be looking for a particular publisher according to the publisher specification(s) available from that publisher. The system of the present invention allows the agency to do this by querying 31 a database of publisher specifications by publisher. The degree to which an agency can access or query the stored data may be governed by the level of subscription to the service, which will typically involve payment of a subscription fee. The agency may access a complete publisher specification or else a subset at the property or channel specification level, or possibly even down to the atom specification level. Access to the specification may be governed by other parameters such as publisher inventory or available media type. The agency can compare 32 and query 33 the publisher specifications for several publishers in this way to find a suitable match. Typically, the agency will define a desired specification to be met and which can be used to query the publisher specification database to find a match.

The agency is able to download 34 the results of the search in various file formats, (e.g. CSV, Excel and HTML) and ordered according to various elements of the specifications, including Ad Unit type, publisher/property/channel, and media. The results will indicate the lowest common denominator for each relevant element of the specification and a link will be provided to the relevant atom specifications for the purpose of testing.

Once a suitable publisher has been identified, the agency can then test 35 their creative against a publisher specification, either at a general level or at the atom specification level, subject to the level of access provided by the agency's subscription to the service. Use of the testing facility may be dependent on test tokens, which may be made available to the agency as part of their subscription or else purchased as and when required. For example, if the agency has logged in to the system and has no tokens available, it will be redirected to buy further tokens a token system is used, and

Preflight testing then proceeds in the manner previously described, with red, amber or green findings according to whether, respectively, the creative fails 36, partially complies 37 or passes 38 the pre-flight test. Subject to adequate compliance with the pre-flight testing, the agency may then conduct manual tests 39 against a checklist to cover elements of the specification that are not covered by the automatic testing or which automatic testing was unable to verify. The system also assigns a unique certification code to the tested creative and the tested creative subsequently submitted to the publisher.

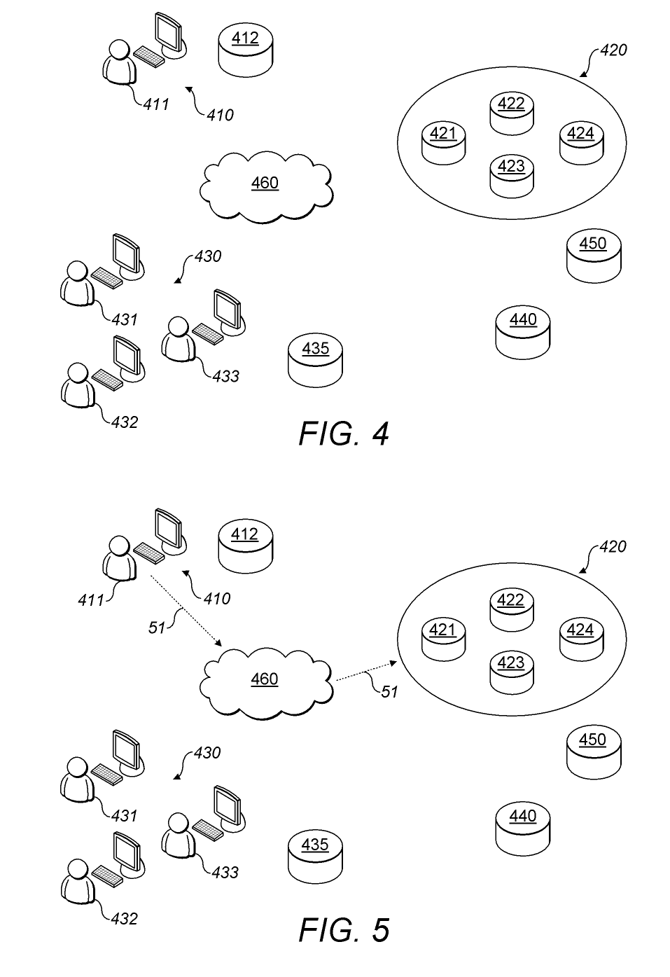

FIGS. 4 to 21 illustrate, in more detail, the interactions that occur between the various parties, which are involved in the publisher-initiated web publication workflow described above, and the on-line creative system (OCS). FIG. 4 shows the overall process, whereby a publisher 410, more specifically a publisher trafficker 421, interacts with the OCS system 420 and the agency 430 via the internet 460. The OCS 420 maintains four key databases, namely a job database (Job DB) 421, a publisher database (Publisher DB) 422, a specification database (Specification DB) 423 and an agency database (Agency DB) 424. The agency 430 will typically have and agency account manager 431, an agency trafficker 432, an agency production team 433 and a production server 434, which may be located remotely. The application software may be run locally on the agency desktop or accessed on a remote server via the internet. Also accessible are remote staging servers, such as the Vio staging server 450, and also Ad servers, which include the publisher's own Ad server 412 and also third party Ad servers 440.

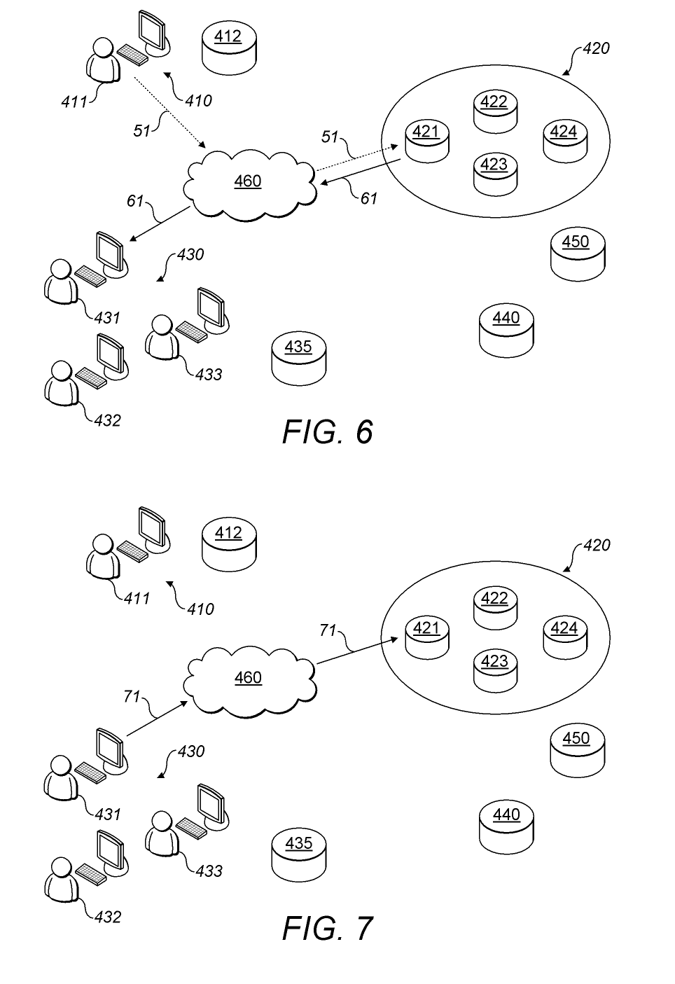

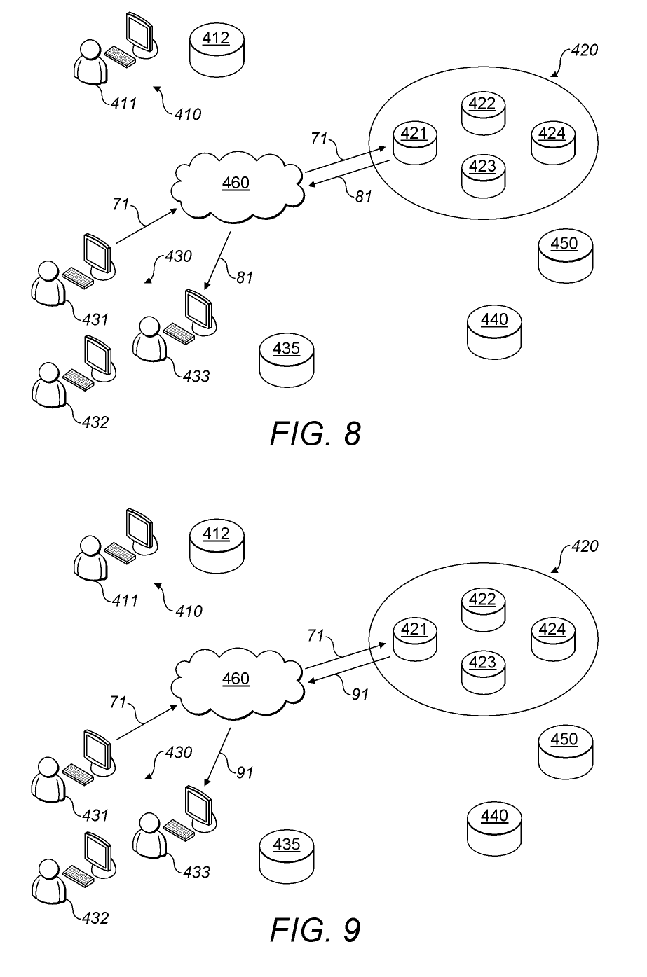

FIG. 5 shows the commencement of the publisher initiated workflow, whereby the publisher trafficker 411 creates and submits 51 a Job Ticket to the OCS 420 via the internet 460. The job ticket is stored in the Job database 421 and, as shown in FIG. 6, the OCS 420 creates a Job Bag for the job and alerts 61 the agency account manager 431 that a job has been submitted. As illustrated in FIG. 7, the agency account manager 431 can then access 71 and view the Job Ticket to review the content, prior to assigning 81 the various Line Items to the relevant production team 433, or teams, for generation of the associated creative, as shown in FIG. 8. Once this assignment has been made, the OCS 420 alerts the respective production team(s) 433 that Line Items have been allocated to them, as shown in FIG. 9.

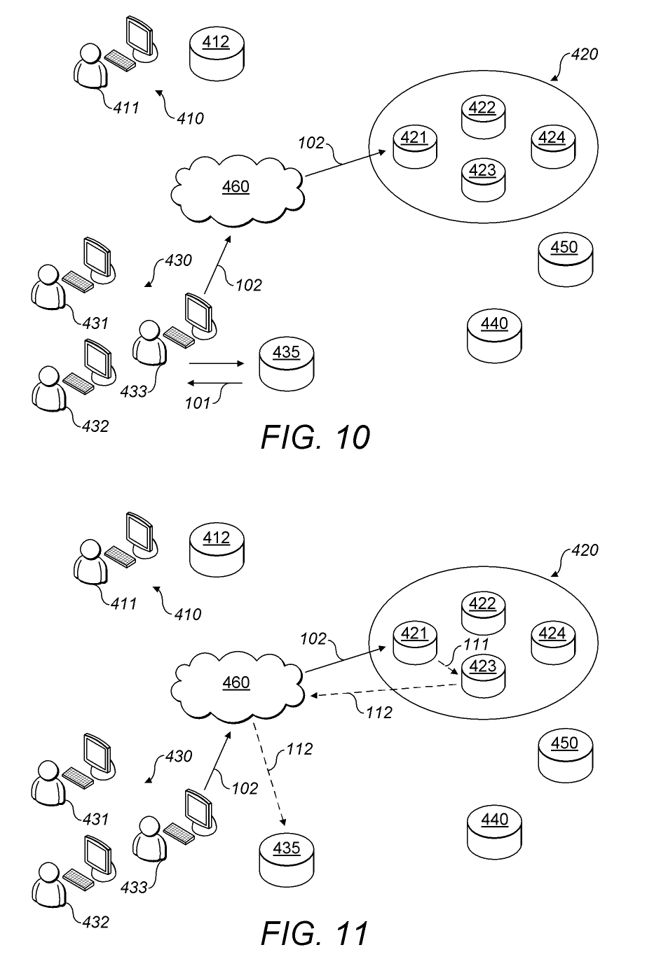

The various production teams 433 can then commence work on generating the creative elements assigned to them, aiming to comply with the relevant specifications. As shown in FIG. 10, the production team 433 members will typically interact 101 with a production server 435 during this task. Once the creative has been completed it can be submitted for preflight testing. In principle the creative itself could be submitted, but in practice the production team 433 actually places 102 tags to the creative into the Line Item folders for testing. The OCS 420 can then query 111 the relevant test scripts from the specification database 423 according to the associated Job Ticket number and use these to test the creative, which is accessed 112 from the production server by means of the tags supplied, as shown in FIG. 11.

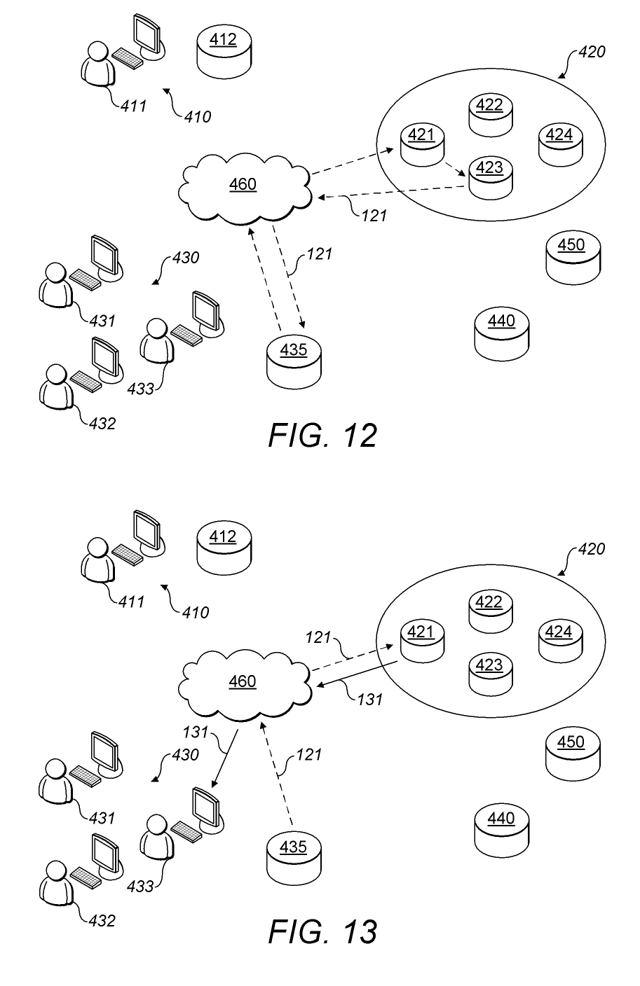

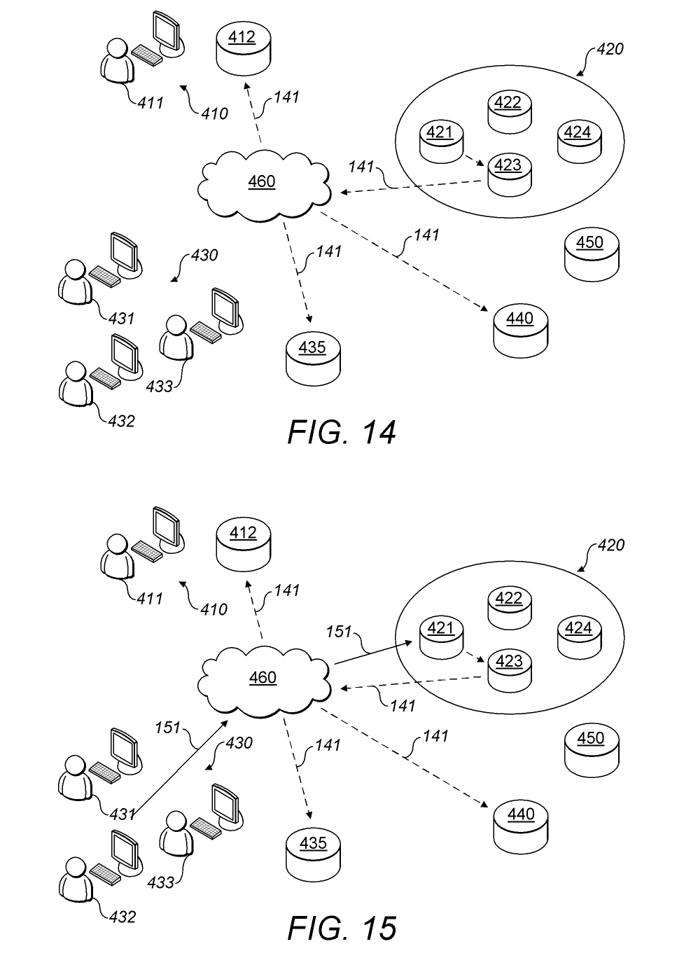

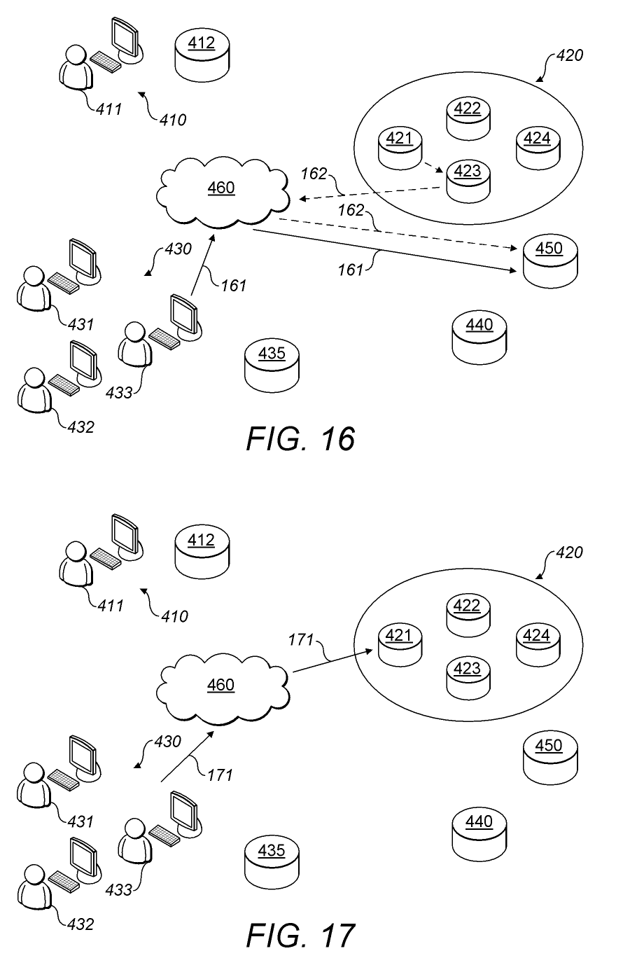

As shown in FIGS. 12 and 13, the results of the test are written 121 to the Job Bag, and the OCS 420 presents 131 the results of testing to the relevant agency production unit 433. Additionally, the OCS 420 provides 131 a checklist of specification items that could not be automatically tested, so that manual quality assurance (QA) checks may be performed at this stage. As shown in FIG. 14, the test may be run 141 by the OCS 420 on any suitable server, including the agency production server 435, or other remote ad servers with a staging facility, such as a publisher ad server 412 or third party ad servers 440. Alternatively, as illustrated in FIG. 15, it may be an agency trafficker 432 who conducts the tests 151 by running them 141 on one or more of these servers. Furthermore, as shown in FIG. 16, the Vio system itself may include a remote staging server 450 that can be accessed and used to conduct the testing. In this case, the production team 433 may have uploaded creative 161 to the Vio staging server 450 to conduct testing 162. For example, if no other staging servers are available or their production server 435 is fire walled.

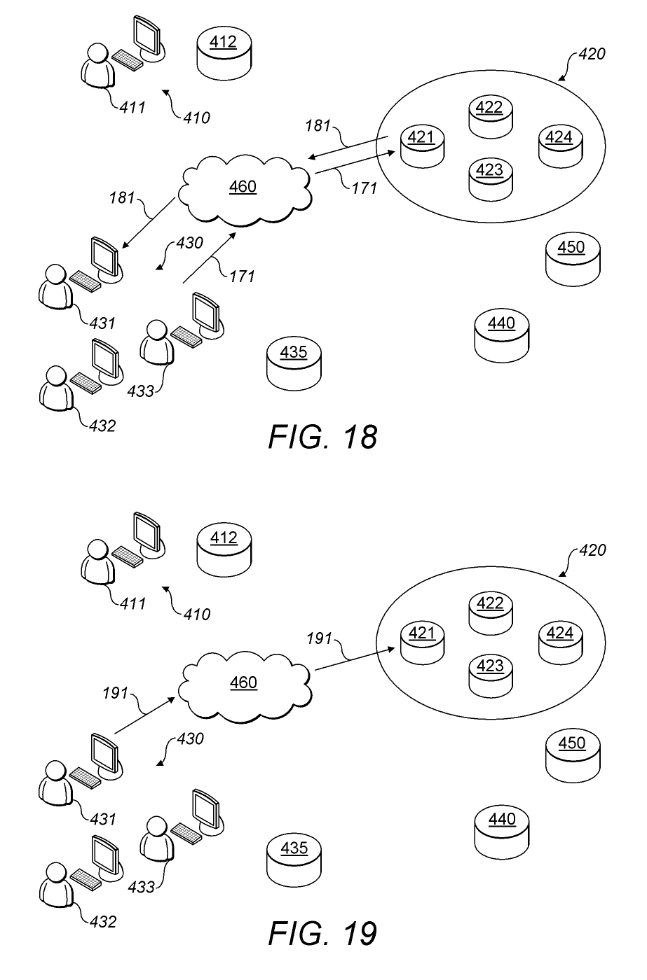

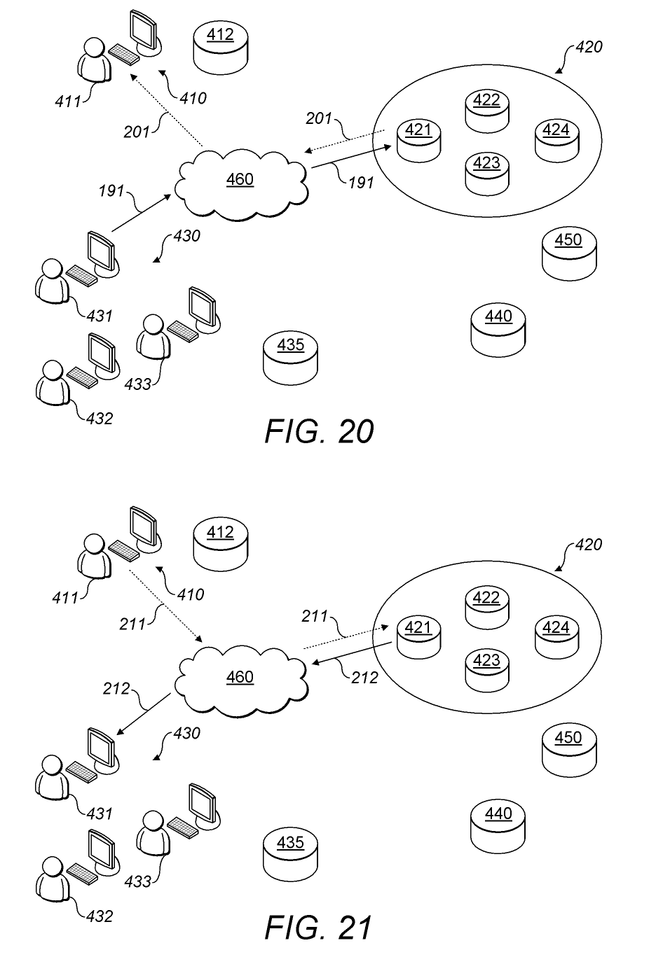

Once testing, manual quality assurance and any remedial action has been completed, the agency production unit 433 (or possibly an agency trafficker 432) verifies the job as complete 171 and the OCS 420 then alerts 181 the agency accounts manager 431 of this competed status, as indicated in FIGS. 17 and 18. The agency accounts manager 431 may then perform any final testing and quality assurance checks 191 of their own prior, as shown in FIG. 19, prior to confirming that the job is complete, at which point the OCS 420 alerts 201 the publisher trafficker 411 that the agency 430 has completed the job, as shown in FIG. 20. The publisher trafficker 411 can then review and approve the job, as illustrated in FIG. 21. During this stage, the publisher trafficker may conduct testing of their own 211, and will certainly have visual and editorial quality assurance tests to conduct, prior to approving the job. Once approved the OCS 420 alerts 212 the agency account manager 431 that the job has been approved.

As will be appreciated by those skilled in the art, the present invention provides an innovative and flexible method and system for preflighting content intended for web publication, whereby the publisher is able to specify the preflighting checks to be applied. The preflighting checks take into account a hierarchical publisher specification, with a lowest level atom specification corresponding to particular publisher inventory. The system facilitates a convenient form of workflow, both from the perspective of the publisher and the ad agency. Identification references can be associated with an electronic document to be pre-flight tested, which enables tracking, auditing and reconciliation. Moreover, further checks, such as certification codes, can be built into the pre-flight tested creative, enabling greater security. Other variations on the system will become apparent to those skilled in the art.

TABLE 1
STANDARD CREATIVE TESTS AND CHECKS

| | | IAB | Auto | Manual |
|---|---|---|---|---|
| Item | Description | Standard | Check | Check |
| File types | The file types acceptable for that | | X | |
| accepted | particular Atom Spec. | | | |
| Width of the | The width of that Ad Unit in | Yes | X | |
| creative | pixels. | | | |
| Height of the | The height of that Ad Unit in | Yes | X | |
| creative | pixels. | | | |
| Maximum file | The maximum file size in | TBC | X | |
| size | kilobytes. | | | |
| Alt Text required | Is Alt Text required? | | X | |
| Maximum Alt | If ‘yes’, how many characters | | X | |
| Text characters | (including spaces) are permitted | | | |
| | as a maximum? | | | |
| Third party tags | Can the subject of this Atom | | | X |
| accepted | Spec (Ad Unit/format/channel) | | | |
| | be served via a 3^{rd} party? | | | |
| Third party | Whether served locally or via a | | | X |
| tracking | 3^{rd} party (if permitted), can 3^{rd} | | | |
| accepted | party tracking be used? | | | |
| Maximum | Is there a limit to the number of | | | X |
| creatives per | separate creatives that can be | | | |
| campaign | rotated within a campaign on the | | | |
| | subject of this Atom Spec? | | | |
| Display method | How will the creative be | | | X |
| | incorporated into the page | | | |
| | (Javascript, Iframe, both, none)? | | | |
| Border required | Is a border required for certain | | | X |
| | backgrounds? | | | |
| Border width | If ‘yes’ what width should the | | | X |
| | border be? | | | |
| Border colour | If ‘yes’ which colours are | | | X |
| | permissible? | | | |
| Editorial match | Does the creative match the | | | X |
| | Editorial Specification provided? | | | |
| Clickthrough | Does the subject of this Atom | | | X |
| allowed? | Spec allow clickthroughs? | | | |
| Clickthrough in | If yes, must the Clickthrough | | | X |
| new window | trigger a new window? | | | |

TABLE 2
RICH MEDIA TESTS AND CHECKS

| | | IAB | Auto | Manual |
|---|---|---|---|---|
| Item | Description | Standard | Check | Check |
| File types and | The file types acceptable for that | | X | |
| versions accepted | particular Atom Spec. | | | |
| Width of the | The width of that Ad Unit in | | X | |
| creative | pixels. | | | |
| Height of the | The height of that Ad Unit in | | X | |
| creative | pixels. | | | |
| Expand accepted | Does the subject of this Atom | | | X |
| | Spec allow expandable units? | | | |
| User initiated | If ‘yes’, does the expand have to | | | X |
| expand | be user initiated and can this be | | | |
| | on roll-over? | | | |
| Maximum expand | The maximum expand width in | | | X |
| width | pixels. | | | |
| Maximum expand | The maximum expand height in | | | X |
| height | pixels. | | | |
| Horizontal expand | When expanding, in which | | | X |
| direction | horizontal direction/s can the | | | |
| | expand take place. | | | |
| Vertical expand | When expanding, in which | | | X |
| direction | vertical direction/s can the | | | |
| | expand take place. | | | |
| Maximum initial | The maximum initial download | | X | |
| file download size | file size in kilobytes. | | | |
| Maximum total file | The maximum total file size in | | X | |
| size | kilobytes. | | | |
| Maximum | What is the maximum total time | | X | |
| animation time | an animation can run? | | | |
| Maximum Frames | How many FPS are permitted as | | X | |
| per Second (FPS) | a maximum? | | | |
| Maximum number | If an animation repeats, what is | | | X |
| of loops | maximum number of times a | | | |
| | repeat is permitted? | | | |
| Sound accepted | Is sound permitted? | | | X |
| Sound user | If ‘yes’, does the sound have to | | | X |
| initiated | be user initiated and can this be | | | |
| | on roll-over? | | | |
| Close button | Is a close button required on | | | X |
| requirement | animations? | | | |
| Close button load | If ‘yes’, where and when must | | | X |
| rules | the close button appear? | | | |
| Alternative | Is an alternative standard file | | X | |
| standard file | required if rich media cannot be | | | |
| required | run (has to comply to standard | | | |
| | criteria above)? | | | |
| Alt Text required | Is Alt Text required? | | X | |
| Maximum Alt Text | If ‘yes’, how many characters | | X | |
| characters | (including spaces) are permitted | | | |
| | as a maximum? | | | |
| Third party tags | Can the subject of this Atom | | | X |
| accepted | Spec (Ad Unit/format/channel) | | | |
| | be served via a 3^{rd} party? | | | |
| Third party | Whether served locally or via a | | | X |
| tracking accepted | 3^{rd} party (if permitted), can 3^{rd} | | | |
| | party tracking be used? | | | |
| Rich media | Which rich media vendors are | | | X |
| vendors accepted | permitted? | | | |
| Maximum | Is there a limit to the number of | | | X |
| creatives per | separate creatives that can be | | | |
| campaign | rotated within a campaign on the | | | |
| | subject of this Atom Spec? | | | |
| Display method | How will the creative be | | | X |
| | incorporated into the page | | | |
| | (Javascript, Iframe, both, none)? | | | |
| Border required | Is a border required for certain | | | X |
| | backgrounds? | | | |
| Border width | If ‘yes’ what width should the | | | X |
| | border be? | | | |
| Border colour | If ‘yes’ which colours are | | | X |
| | permissible? | | | |
| Editorial match | Does the creative match the | | | X |
| | Editorial Specification provided? | | | |
| Clickthrough | Does the subject of this Atom | | | X |
| allowed? | Spec allow clickthroughs? | | | |
| Clickthrough in | If yes, must the Clickthrough | | | X |
| new window | trigger a new window? | | | |
| Click tag required | Is a specific click tag required? | | | X |
| Click tag form | If ‘yes’, how should the click tag | | | X |
| | be configured? | | | |

1. A computer-implemented method of preflighting an electronic document containing content provided by a first party and intended for web-based publication by a second party, the method comprising the steps of:
accessing the electronic document from the first party;
checking characteristics of the document for compliance with a set of rules, the rules being predefined by the second party and corresponding to specifications for web publication of content by the second party;
providing to the first party an indication of the level of compliance of the document characteristics with the predefined rules; and,
submitting the preflighted document for web publication of the content by the second party subject to the level of compliance.

2. The method according to claim 1, wherein the indication comprises a failed level of compliance and the method further comprises the step of indicating to the first party how to correct errors in the document for compliance.

3. The method according to claim 1, wherein the indication comprises an adequate level of compliance and the method further comprises the step of sending to the first party an invitation to either correct errors in the document and resubmit it for further preflighting or to authorise submission of the preflighted document including the errors for web publication of the content by the second party subject to acceptance of conditions specified by the second party.

4. The method according to claim 3, further comprising the steps of:
receiving authorisation from the first party in response to the invitation;
submitting the preflighted document including the errors for web publication of the content by the second party together with the indication of the level of compliance; and,
sending a confirmation to the first party that the document has been submitted.

5. The method according to claim 1, wherein the indication comprises an adequate level of compliance and the method further comprises the steps of:
automatically correcting errors in the document;
submitting the corrected preflighted document for web publication of the content by the second party together with the indication of the level of compliance; and,
sending a confirmation to the first party that the document has been submitted.

6. The method according to claim 1, wherein the indication comprises a good level of compliance and the method further comprises the steps of:
submitting the preflighted document for web publication of the content by the second party together with the indication of the level of compliance; and,
sending a confirmation to the first party that the document has been submitted.

7. The method according to claim 1, wherein the predefined set of rules correspond to a publication specification of the second party, the publication specification comprising a hierarchical specification structure.

8. The method according to claim 7, wherein the publication specification comprises a technical specification, a management specification, and an editorial specification.

9. The method according to claim 7, wherein the publication specification comprises one or more channel specifications, each channel specification comprising one or more atom specifications, each atom specification corresponding to a particular type of publisher inventory

10. The method according to claim 1, wherein the predefined set of rules are accessed from a remote server.

11. The method according to claim 1, wherein the predefined set of rules can be modified by the second party.

12. The method according to claim 1, wherein the set of predefined rules applied to the document is dependent on the identity of the first party.

13. The method according to claim 1, wherein the level of compliance required for submission of the document is dependent on the identity of the first party.

14. The method according to claim 1, further comprising the steps of:
assigning a identification reference to the submitted document; and
sending the identification reference to the first party.

15. The method according to claim 1, further comprising the steps of:
receiving an identification reference from the first party, the identification reference being associated with the electronic document and the second party; and
checking the identification reference against data supplied by the second party.

16. The method according to claim 15, wherein submission of the document for web publication of the content by the second party is subject to validation of the identification reference against the data received from the second party.

17. The method according to claim 15, wherein in which the set of predefined rules applied to the document are dependent on the identification reference.

18. The method according to claim 15, further comprising the steps of:
receiving metadata associated with the identification reference; and,
preflighting the metadata by checking characteristics of the metadata for compliance with a set of rules, the set of rules being predefined by the second party and corresponding to specifications for the type and form of metadata.

19. The method according to claim 18, wherein the step of submitting the preflighted document for publication of the content by the second party comprises the steps of:
forwarding the preflighted document to a third party specified by the second party for web publication of the content on behalf of the second party; and,
forwarding the preflighted metadata associated with the identification reference to the second party for reconciliation purposes.

20. The method according to claim 1, wherein the electronic document contains metadata associated with the content and the set of predefined rules includes rules corresponding to specifications for the type and form of the metadata.

21. The method according to claim 1, wherein during testing of the electronic document the method further comprises the step of:
creating a unique certification code associated with the content in the preflighted electronic document intended for web publication by applying an algorithm to one or more aspects of the content.

22. The method according to claim 19, wherein the unique certification code is included in an Ad Call served as part of a web page for the second party.

23. The method according to claim 1, wherein the content comprises an advertisement.

24. The method according to claim 1, wherein the set of rules include rules corresponding to specifications for static media format parameters selected from a group which includes: file format, file weight, border requirements, font, and physical dimensions of formatted content

25. The method according to claim 1, wherein the set of rules include rules corresponding to specifications for rich media format parameters selected from a group which includes: file type, file weight, file size, the existence of user controls, the number of animation loops, physical expansion limits, and duration of display.

26. The method according to claim 1, further comprising the steps of:
identifying in the document embedded links to external sources of content;
accessing the content from the external sources via the embedded links; and,
checking characteristics of the external content for compliance with the set of rules predefined by the second party.

27. The method according to claim 26, wherein the set of rules include rules corresponding to specifications for embedded information which includes: website links, tags for searching, and tags for tracking.

28. The method according to claim 26, wherein the set of predefined rules includes rules corresponding to specifications for the security status of links to external sources of content.

29. The method according to claim 26, wherein the external sources comprise third party hosted websites.

30. A computer program product comprising computer executable code for implementing the method of claim 1.

31. A networked computer system for preflighting an electronic document containing content provided by a first party and intended for web-based publication by a second party and for managing the workflow between the first party and the second party, the system comprising:
a first database comprising data relating to particular web publication jobs;
a second database comprising data relating to second party publishers of web content;
a third database comprising data relating to specifications for web published content;
a fourth database comprising data relating to first party providers of content intended or web publication; and,
a processor adapted to execute computer code for performing the method of claim 1, the processor being in communication with each of the first, second, third and fourth databases.

32. An networked computer system according to claim 31, wherein the first, second, third and fourth databases are accessible over the internet.

33. An on-line system according to claim 31, further comprising one or more computer terminals having a graphical interface whereby the first and/or second party can interact with the system.
